(19) United States
(12) Patent Application Publication
(10) Pub. No.: US 2001/0011818 A1
(43) Pub. Date: Aug. 9, 2001

(54) SYSTEM AND METHOD FOR PROMOTING STORES AND PRODUCTS

(75) Inventors: RODNEY L. DOCKERY, DALLAS, TX (US); CALEB J. PIRTLE, ENNIS, TX (US)

Correspondence Address: David H. Tannenbaum, Fulbright & Jaworski L.L.P., 2200 Ross Avenue, Suite 2800, DALLAS, TX, 75202, US

(73) Assignee: HERITAGE PUBLISHING, INC.

(21) Appl. No.: 08/813,852

(22) Filed: Mar. 7, 1997

(51) Int. Cl. B42D 5/00; B42D 17/00; E04H 3/00

(52) U.S. Cl. 281/15.1; 281/37; 281/43; 281/38

(57) ABSTRACT

A method for promoting sales of a plurality of national and/or store brand products carried in a plurality of departments of a store. Information about the store brand products is collected, assembled, and referenced in first, second, and third publications, designated for respective weekly, monthly, and quarterly publication, which publications are visually identifiably associated with each other. Coupons are appended to the publications for enabling customers to purchase the respective products at a discount. The publications are displayed, proximate to the respective products being promoted in the publications, for appropriation by customers.

### BACKGROUND OF THE INVENTION

The present invention relates to a system and method for promoting stores and products and, more particularly, to such a system and method for segmenting stores, such as chain stores, mass merchandisers, drug stores and supermarkets, creating within each individual store distinct and separate retail departments, thereby enabling a more efficient and effective way to promote, market, merchandise and increase the sales of national brand and store brand or private label products. Such a system and method emphasizes the utilization of books, brochures and magazines—which can be supported by newsletters, additional printed materials, radio, television, audio-visual and internet web pages—to solidly establish and create a community of stores within each individual store that is a part of a particular chain, positioning each individual store as a singular destination that becomes a lifestyle improvement, enhancement and enrichment center for those consumers who shop there.

Retail chains, mass merchandisers, drug outlets and supermarkets have dramatically altered the character and merchandising focus of their stores. No longer are these stores singular minded. Now they offer a varied array of products covering a broad spectrum of categories.

Grocery stores, for example, are no longer in the business of exclusively selling grocery products. Grocery stores also have separate departments designed to market products for health care, beauty care, child care, skin care, hair care, eye care, foot care, first aid, nutrition, physical fitness, pet care, greeting cards, automotive, outdoor recreation, photography, office supplies and school supplies, as well as film processing, videos and a pharmacy for prescriptions.

Mass merchandisers, including traditional department stores and special interest stores, can be segmented into individual departments that promote pharmacies for prescriptions, food and cookware, health, nutrition, beauty care, physical fitness, skin care, hair care, eye care, outdoor recreation, pet care, photography, videos, home and backyard parties, gardening, home repair and remodeling, automotive, travel, office supplies, leisure and professional attire, infant and toddler clothing, and toys, in addition to supplies, shoes and equipment for hunting, fishing, camping, hiking and backpacking, as well as supplies, shoes and equipment for such recreational sports as golf, tennis, football, baseball, softball, basketball and roller blading.

Drug stores showcase individual departments that feature pharmacies for prescriptions, as well as an assortment of unrelated products promoting food and cookware, health, nutrition, physical fitness, beauty tips, hair care, eye care, child care, first aid, foot care, pet care, photography, automotive, travel, home decorating and outdoor recreation.

Historically, retail chains, mass merchandisers, drug outlets and supermarkets have marketed their stores as singular places that happen to have a variety of merchandise. The store itself, not the individual departments within the store, was advertised and promoted.

By utilizing this invention, retail chains, mass merchandisers, drug outlets and supermarkets have a system and method whereby they can successfully market the national brand and, more particularly, store brands within each individual department of the store. Each individual department thus becomes a place of special prominence and importance, provided additional credibility by a specific editorial environment created especially for that department within the pages of magazines, books and brochures, which can be supported by tie-in newsletters, other printed materials, radio, television, audio-visuals and internet web pages.

The present invention, accordingly, provides a system and method for economically promoting store brand products, in addition to national brand products, in each department through the use of discount coupons, as well as other advertising methods, so that the price and sales volume of, and hence net profits from, these products may be increased.

To this end, the system and method of the present invention comprises collecting and assembling information about the products, and referencing the collected and assembled information in a plurality of publications, designated for respective weekly, monthly and quarterly publications.

Coupons are appended to the publications for enabling customers to purchase the respective products in each singular department at a discount, and the publications are displayed proximate to the respective products being promoted in the publications for appropriation by customers.

Currently, national brand products are heavily promoted through, for example, advertisements on television, in magazines and in newspapers, so that a relatively high consumer demand for the products can be maintained. As a consequence of the high consumer demand, relatively high prices and, hence, high profit margins, as well as high sales volume, of the products can be maintained. Though the costs of such promotion are relatively high, the costs can be allocated over the resulting large volume of sales of high profit margin products, thereby offsetting and economically justifying the promotional costs incurred.

While the promotion of national brands is effective for establishing a national product image, there are several drawbacks associated with such national promotion. For example, national promotion is not very effective for establishing an impulse to buy. Furthermore, because the image which is established is of national breadth, it is difficult to target particular geographical regions of the country. Still further, such promotion is relatively short lived. For example, a television or radio advertisement generally lasts 30 to 60 seconds, and is then quickly replaced with other programming or advertising. Newspaper advertising lasts for only twenty-four hours. Magazine advertising is seldom effective for more than a week or thirty days at a time, and brochures are quickly filed away or thrown away.

The present invention, however, provides a system and method for the manufactures and suppliers of national brand products and store brand products to reach a targeted audience with a targeted advertising and promotional approach. Although the marketing concept may be supported by radio, television, audio-visual and Internet Web page programming linked directly and specifically to the in-store promotion, the nucleus of the invention will be centered in books, magazines and brochures available to customers within singular departments found inside retail chains, mass merchandisers, drug outlets and supermarkets. The invention thus gives these stores and suppliers of national brand and store brand products a system through which they can place their individual messages—in the form of standard advertising or cents-off discount coupons—in the hands of customers while they are inside the stores themselves where seven out of ten buying decisions are ultimately made.

In contrast to the national advertising promotion of name brand products, store brand or “private label” products receive little if any advertising and promotion, making it difficult for store brand products to compete with national brand products on the basis of brand recognition.

However, because there is little if any advertising and promotion of the store brand products, promotional costs associated therewith are not incurred. Store brand products can thus keep costs down and compete with national brand products on a cost basis. Notwithstanding the lower costs, sales of store brand products continue to suffer for at least two reasons. First, store brands lack the credibility of the national brands since the store brands are not as well known in the marketplace as are the national brands. Second, because store brand products are typically sold only through one store or a single chain of stores, sales volume, together with competition on a cost basis, it is not economically justifiable to promote store brand products in the manner that national name brand products are promoted, even though stores realize a much higher profit from the sale of private label merchandise and stores are therefor searching for innovative, effective and economically-feasible ways to create a higher demand for and increase the sales volume of store brand products.

The present invention also provides a system and a method for economically promoting store brand products through the use of discount coupons, as well as traditional advertising methods, and by capitalizing on the aforementioned drawbacks associated with national promotion, so that the price and sales volume of, and hence net profits derived from, store brand products may be increased.

Within books, brochures and magazines, store brand products can be featured alongside national brands, a measure which lends the credibility that private label brands have been lacking throughout the national marketplace. Additionally, both national and store brand products can be promoted through cents-off discount coupons which provide potential customers with a reason to buy, and a vehicle that makes it financially advantageous for them to buy. The production costs, in generally, will be borne by national brand products, yet stores will have a vehicle through which they can successfully promote their private label products as well.

Traditionally, discount coupons are made available to potential customers through various methods, such a direct mail packages or newspapers. The discount coupons are nevertheless often ignored or overlooked by customers, and presently less than two percent of the coupons are redeemed. The present invention, however, utilizes books, magazines and brochures where discount coupons are displayed within publications that are showcased in the near proximity of participating products and offer a viable editorial climate that increases the appeal, the desirability and the credibility of both national brand and store brand products. As a result, suppliers have the distinct opportunity for a much higher redemption rate on their coupons, thereby increasing their sales of the products featured in the cents-off coupons.

### SUMMARY OF THE INVENTION

The present invention, accordingly, provides a system and method for effectively marketing and increasing the sales volume of, and hence net profits from, store brand products, as well as national brand products, by positioning retail chains, mass merchandisers, drug outlets and supermarkets as lifestyle improvement, enhancement and enrichment centers for their customers. The use of books, magazines and brochures—supported by other printed materials, radio, television, audio-visuals and Internet web pages—can promote and merchandise products within each singular department of an individual store or chain of stores, enhancing the appeal and desirability of selected products through the utilization of standard advertising, as well as cents-off discount coupons within the publications. The use of cents-off discount coupons within a marketing program of books, magazines and brochures can also increase the exposure and credibility of store brand products that, historically, have not had the same national advertising recognition as national brand products.

An advantage achieved with the present invention is that retail chains, mass merchandisers, drug outlets and supermarkets can reach shoppers and potential customers with an advertising message, supported by a strong editorial climate, while those shoppers and potential customers are in the stores themselves. Seven out of ten buying decisions are made after a shopper is in the store.

Another advantage achieved with the present invention is that retail chains, mass merchandisers, drug outlets and supermarkets have a means to position themselves as destination centers, educating customers on the broad spectrum of departments and products located within each individual department of the stores. Through the use of in-store books, magazines and brochures, shoppers are taught that they no longer have to shop a variety of stores in order to find the products they need when all these products are available within a particular store which is, in essence, a community of stores within a singular large store.

Another advantage achieved with the present invention is that store brand products can be economically promoted to increase the demand for them and, hence, to increase the profits derived therefrom.

Another advantage achieved with the present invention is that the marketing of relatively small quantities of relatively higher profit margin products, such as store brand products, can be greatly enhanced.

Another advantage achieved with the present invention is that information can be readily and easily disseminated to consumers to help the consumers make better product purchase decisions.

Another advantage achieved with the present invention is that consumers can easily identify sources of information that they need to make wise purchasing decisions.

Another advantage achieved with the present invention is that the discount coupons provide customers with a reason to buy, and a vehicle that makes it financially advantageous for them to buy store brand products, as well as national name brand products.

Another advantage achieved with the present invention is that additional value is provided by the publications, which value provides a further incentive for customers to purchase products from the store with the additional value rather than a competitor store that does not provide any such additional value.

Another advantage achieved with the present invention is that publications such as the books give the store immediate prestige and enhance the store's image in the marketplace.

Another advantage achieved with the present invention is that the publications give the store an opportunity to strengthen its position in the marketplace.

Another advantage achieved with the present invention is that the publications allow the store to generate new customers resulting in increased profits.

Another advantage achieved with the present invention is that the discount coupons generate increased repeat visits to the store by consumers who take advantage of the cents-off opportunities afforded by the publications.

Another advantage achieved with the present invention is that the publications educate customers and create a new awareness for the store's products.

### BRIEF DESCRIPTION OF THE DRAWINGS

FIG. 1 is a plan view of a grocery store in which the system of the present invention is implemented.

FIG. 2 is a flow chart showing a method for implementing the system shown in FIG. 1.

FIG. 3 is a schematic block diagram showing an alternate embodiment of the system of the present invention.

FIGS. 4A and 4B are flow charts showing a method for implementing the system shown in FIG. 3.

### DETAILED DESCRIPTION OF THE PREFERRED EMBODIMENT

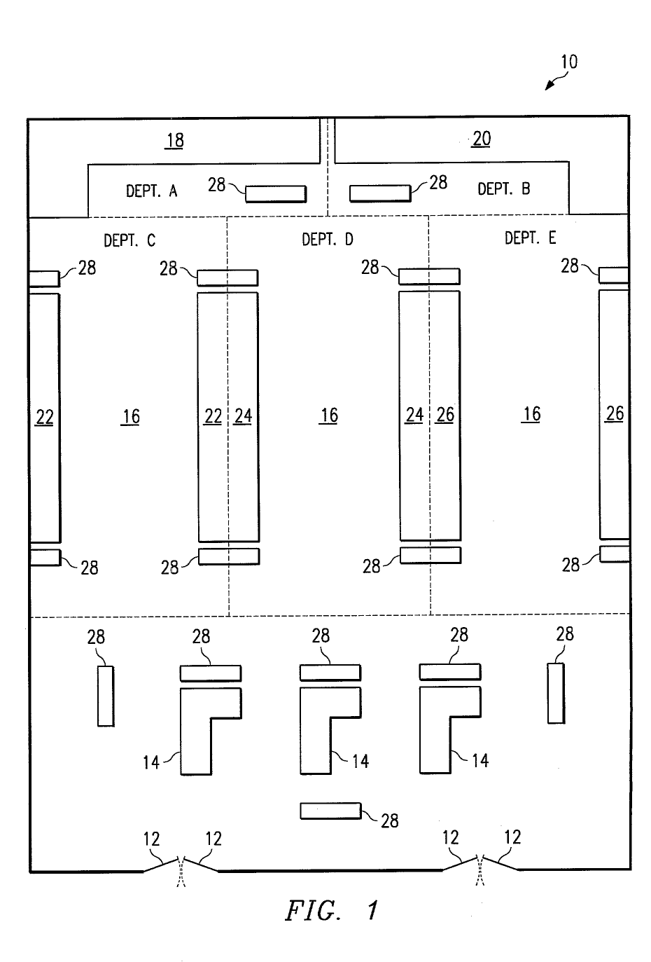

Referring to FIG. 1, the reference numeral 10 illustrates, in general, a representative store, such as a chain store, mass merchandiser, drug store or supermarket, in a chain of such stores. The store 10 includes entry/exit doors 12, checkout registers 14, aisles 16, and five representative departments A, B, C, D, and E, having respective product display shelving units and refrigeration units 18, 20, 22, 24, and 26, configured for storing products such as frozen foods, meats, dry foods, health and beauty care products, and pet care products.

The store 10 merchandises in the departments A, B, C, D, and E a number of products (not shown), such as grocery products, including fresh produce, a wide variety of meats, ethnic foods, bakery products, deli products; cookware and cutlery; health and beauty products including perfumes such as colognes and skin care products, fitness products, and nutritional products; child care products; prescriptive drugs; photographic products and supplies; pet care products; automotive products; school and office supplies; eye care products; home decorating products; clothing and shoes; and supplies and equipment for outside and recreational sports. The foregoing features of the store 10 are well known and therefore will not be described in greater detail herein.

A number of publication display racks 28 are prominently distributed throughout the store 10 and are strategically located so that customers will readily see them. The racks 28, for example, are centrally located in the departments A and B, are located at the ends of the display units 22, 24, and 26, and are located proximate to the entry/exit doors 12 and the checkout registers 14. The racks 28 are configured for displaying a number of different types of promotional publications (not shown) such as brochures, magazines, books, and novels, which are described in greater detail below.

The promotional publications include columns and feature articles, such as stories and recipes, referencing and thereby promoting national and/or store brand products. The publications typically also include within the pages thereof “cents-off” discount coupons for enabling customers to purchase the products being promoted. It is understood that the coupons provided are not limited to cents-off discount coupons, but may include other types of discount coupons, such as mail-in rebate coupons. While not shown, all of the publications further include on the outside covers thereof, the store name, logo, trademark, color scheme, and/or trade dress associated with the store 10 so that, with a quick glance, even from a distance, a customer will realize that the publications will be promoting products, and will typically include discount coupons for such products.

Of the various publications mentioned above, the brochures are the shortest (typically a few pages in length), the most frequently updated (typically weekly), and the most focused with a brochure being provided for each specific department and target marketing that respective market. Because the brochures are relatively short, they usually carry relatively short columns rather than full length feature articles. For example, a column in a brochure may present a cooking recipe or a skin care tip that is only half a page long. In addition to columns and discount coupons, the brochures optionally also include a “menu,” similar to a shopping list, which provides a list of products commonly associated with the products being promoted in the brochure, to thereby assist the customer in getting every item he needs. For example, when a national or store brand of salad dressing is being promoted, a recipe may be for a salad listing as an ingredient the brand of salad dressing being promoted, and the menu may include the salad dressing, along with lettuce, tomatoes, eggs, purple onions, bacon chips, croutons, cheese, pine nuts, carrots, and cucumbers. Because the brochures target market products in specific departments, and because the store 10 has five representative departments A, B, C, D, and E, five brochures are produced each week and are displayed on the racks 28 proximal to each respective department.

In contrast to the brochures, the magazines are directed to national and store brand products carried by all of the departments A, B, C, D, and E in the store 10, and are therefore displayed in the display racks 28 located throughout the store. Additionally, the magazines are published monthly (or bimonthly, or quarterly) rather than weekly as are the brochures. The magazines are also more substantial, having about 96 to 128 pages, and contain full length feature articles which are more extensive than the columns found in the brochures. Pictures of the products featured within the magazine can, in a subtle and tasteful manner, be showcased within the articles. Because the magazines are a store-wide publication, the feature articles contained therein may cross-reference products in other departments. For example, an article in a grocery magazine which discusses the benefits of physical exercise, may mention national or store brand vitamins carried in the health and beauty care products department, and discuss the necessity for protein acquired from meats provided in the frozen foods department. Appropriate discount coupons are included for some of the highlighted items.

The series of books carried in the store 10 are designed to promote each specific department and is published periodically, such as quarterly, semi-annually, or annually, and typically references products that are also referenced in the weekly brochures for a respective department. As with the brochures and the magazines, the books include discount coupons, such as “cents off” coupons for providing a financial incentive for the customer to purchase products referenced in the books, as well as to purchase the books themselves if the store 10 does not give them away for free. Each series of the books is oriented around a central theme relating to the department to which the series is directed. A subject or topic discussed in a magazine may be expanded and developed into a theme in a book. For example, the aforementioned magazine article about physical exercise may be expanded and developed into a feature article about skiing in the snow covered mountains of Colorado. Such an article would preferably also include pictures of skiers skiing down the slopes, and may reference products in addition to what are referenced in the magazines, such as a national or store brand of sun tan lotion to protect a skier's skin from the bright sun. The books may reference other products also, such as skis which may or may not carried by the store 10.

Novels are also published and are displayed on the display racks 28 throughout the store 10 with the foregoing brochures, magazines, and books. The novels depict popular themes, such as romance and/or adventure, as well as books for children and young adults, which can include within the text thereof references to national and store brand products. The novels may optionally include discount coupons similar to those discussed above with respect to the aforementioned brochures, magazines, and books.

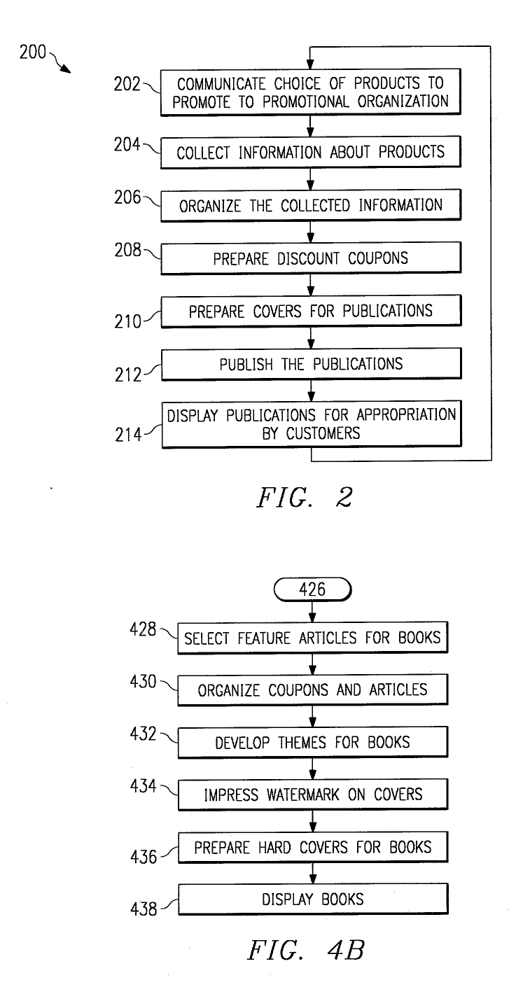

FIG. 2 shows a method 200 for implementing the details of producing the foregoing publications in accordance with the present invention. In step 202, the store 10 communicates its choice of products to be promoted to a promotional organization (not shown) having a staff of research, editorial, photography, and marketing personnel. An example of such an organization is Heritage Publishing, Inc. located in Dallas, Texas. The store 10 also provides the promotional organization with information relating to other promotions, such as in-store promotions and campaigns that the store is conducting for the products selected to be promoted.

Upon the completion of step 202, the promotional organization, in step 204, conducts research to collect additional information, including photographs, about the products to be promoted and how they may be used by the consumer. For example, if national and/or store brand items are to be promoted, then information collected in step 204 may include food recipes that call for the national and/or store brand food, and pictures showing the food after it has been prepared in accordance with the recipes. If sun screen, for example, is to be promoted, then the information may include descriptions and photographs of outdoor activities such as skiing in Colorado or swimming at a beach, and remind the consumer why it is important that the national and/or store brand of sun screen be used during such activities. If vitamins are to be promoted, then the information may describe the benefits of improving one's personal physical fitness and how the national and/or store brand vitamins help the consumer attain that end.

In step 206, the promotional organization's editorial staff organizes the collected information, including pictures, and writes columns and feature articles which reference one or more of the products being promoted. For example, an article describing skiing in down the slopes of mountainous Colorado may, in addition to referencing the national and/or store brand of sun screen, also reference the store's brand of Vitamin E and discuss the benefits of using it to help avoid sun damage to one's skin. Assuming that the store 10 does not carry its own brand of skis, the same article may also reference a national name brand of skis used on the slopes in Colorado.

In step 208, cents-off discount coupons are prepared for insertion into the publications for enabling customers to purchase at reduced prices the national and/or store brand products referenced in the columns and articles. It is understood that the coupons provided are not limited to cents-off coupons, but may include other types of discount coupons, such as mail-in rebate coupons. In step 210, covers are prepared for the publications. The store name, trademark, and/or logo, along with any color scheme and/or trade dress associated with the store 10 are imprinted on the cover. A picture of the products being promoted may also be imprinted on the covers thereof.

In step 212, the foregoing feature articles (including pictures), discount coupons, and covers are published in a conventional manner. More specifically, the feature articles are laid out with the pictures appropriately integrated into them. Additionally, the store's name, trademark, and/or logo are laid out as desired on each page of the feature articles, for example, at the top and/or bottom of each page. The feature articles, discount coupons, letter from a store official, and cover are mass reproduced and arranged in an order desirable for publication. The letter is positioned to precede the feature articles, and the discount coupons are positioned by advertisers to tie into feature articles referencing the products for which the coupons apply. The feature articles, discount coupons, and letter are then separately bound together for each publication, and the cover is secured thereabout. A different publication, with different articles and design elements, are published for each separate store chain.

In step 214, the publications are displayed proximate to the product or products for which they are intended to promote. The publications are thus made available for use and appropriation by customers. It is understood that the foregoing steps 202-214 are repeated periodically for each publication. For example, the steps 202-214 can be repeated weekly for the brochures, monthly for the magazines, and quarterly for the books. It is also understood that the content of each type of publication will vary, i.e., brochures may not include a letter from a store official and magazines may have a higher percentage of photographs.

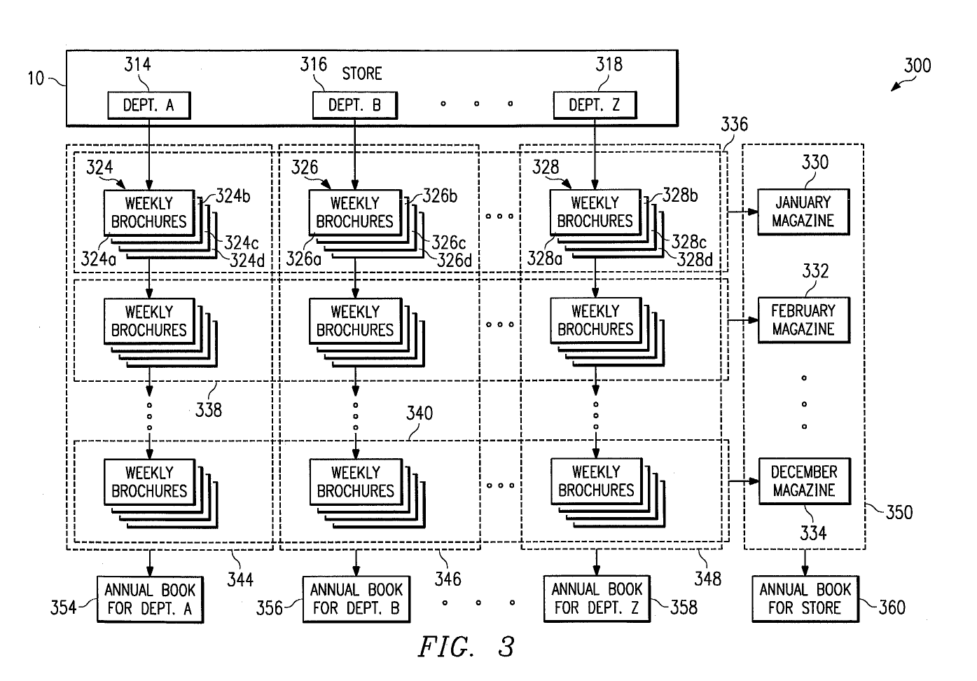

In FIG. 3, the reference numeral 300 illustrates, in general, an alternate embodiment for a system for promoting national and/or store brand products in accordance with the present invention. The system 300 is illustrated with respect to a store 310 similar to the aforementioned store 10, and includes a timed distribution of publications, described below, for promoting national and/or store brand products that the store 310 desires to promote in the various departments A and B through Z during predetermined times of the year. Though the system 300 is adaptable for use with any number of departments, it will be described herein with respect to only three departments 314, 316, and 318.

The system 300 comprises weekly brochures 324, 326, and 328, including brochures 324a, 326a, and 328a, respectively, for promoting during the first week of a month, such as January, selected national and/or store brand products carried in each of the departments 314, 316, and 318, respectively. The brochures 324a, 326a, and 328a are displayed in the respective departments 314, 316, or 318 and are made available to customers for no charge. The displayed brochures 324a, 326a, and 328a are subsequently replaced in the second week of the respective month with brochures 324b, 326b, and 328b; in the third week with brochures 324c, 326c, and 328c; and in the fourth week with brochures 324d, 326d, and 328d; each of which promote a new selection of products in the departments 314, 316, and 318. It is understood that in some months, when it is desirable, a fifth weekly brochure (not shown) may also be published which could carry over to the following month.

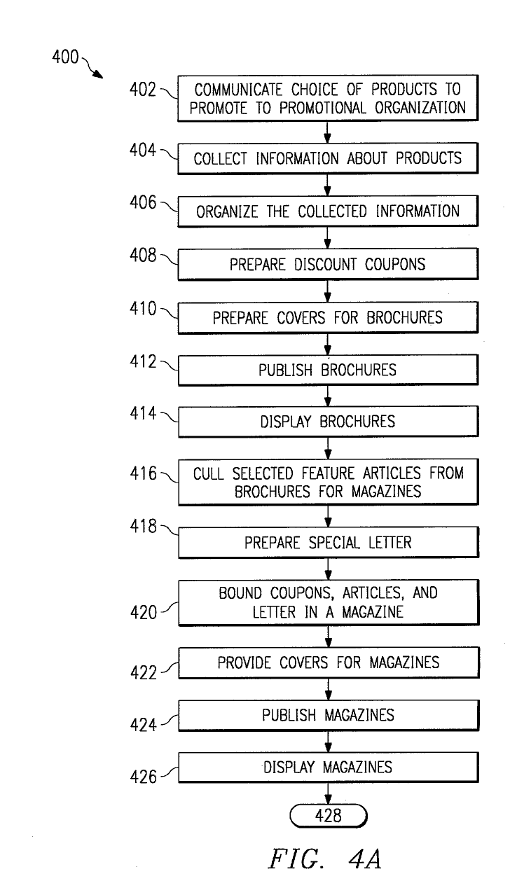

At the end of each month, after which four or five brochures 324, 326, and 328 have typically been published and displayed in each respective department 314, 316, and 318, a magazine, such as a magazine 330, 332, or 334, is published, as described below with respect to FIG. 4. The magazine 330, for example, is published at the beginning of the month of January, and includes selected portions taken from each of the brochures 324, 326, and 328 to be published in January, the brochures being indicated in FIG. 3 by the dashed outline 336. Because the magazine 330 includes promotions for products carried in each of the departments 314, 316, and 318 of the store 310, it is displayed in each department throughout the store and, like the brochures, made available to customers at no charge or at a subsidized amount. Each displayed magazine 330, 332, and 334 is subsequently replaced each month with a new magazine promoting the products promoted in the brochures published during the same month. For example, the January, February, and December magazines 330, 332, and 334, respectively, are replaced by the respective February magazine 332, the March magazine 334, and the January magazine (not shown) published in the following year. The January, February, and December magazines 330, 332, and 334, respectively, promote products promoted in the brochures designated by the dashed outlines 336, 338, and 340, respectively.

At the end of each year or each quarter, selected portions of the brochures 324, 326, and 328 or magazines 330, 332, and 334 that have been published during such period, designated by the dashed outlines 344, 346, 348, and 350 for the respective departments 314, 316, and 318, and for the store 310, are embellished and compiled into respective books 354, 356, 358, and 360 as described below with respect to FIG. 4, for promoting the selected national and/or store brand products carried during such period in each of the departments, and in the store. The book 354, for example, includes selected portions taken from the brochures 324 enclosed by the dashed outline 344. The books 354, 356, and 358 are displayed in their respective departments, and the books 360 are displayed throughout the store, and can be sold or made available to customers for no charge until the supply of books has been exhausted.

FIG. 4 shows a method 400 for implementing the details of generating publications, such as the weekly brochures 324, 326, and 328, in accordance with the present invention. In step 402, the store 310 communicates its choice of products to be promoted to a promotional organization (not shown) having a staff of research, editorial, photography, and marketing personnel. An example of such an organization is Heritage Publishing, Inc. located in Dallas, Tex. The store 310 also provides the organization with information relating to other promotions, such as in-store promotions and campaigns that the store is conducting for the products selected to be promoted.

Upon the completion of step 402, the promotional organization, in step 404, conducts research to collect additional information, including photographs, about the products to be promoted and how they may be used by the consumer. For example, if store brand food items are to be promoted, then information collected in step 404 may include food recipes that call for the store brand food, and pictures showing the food after it has been prepared in accordance with the recipes. If national brand sun screen is to be promoted, then the information may include descriptions and photographs of outdoor activities such as skiing in Colorado or swimming at a beach, and remind the consumer why it is important that the national brand of sun screen be used during such activities. If national or store brand vitamins are to be promoted, then the information may describe the benefits of improving one's personal physical fitness and how the national or store brand vitamins help the consumer attain that end.

In step 406, the promotional organization's editorial staff organizes the collected information, including pictures, and writes feature articles which reference one or more of the products being promoted. For example, an article describing skiing in Colorado may, in addition to referencing the store's brand of sun screen, also reference the store's national or private label brand of Vitamin E and discuss the benefits of using it to help avoid sun damage to one's skin. Assuming that the store 310 does not carry its own brand of skis, the same article may also reference a national name brand of skis used on the slopes in Colorado.

In step 408, cents-off discount coupons are prepared for insertion into the brochure 324, 326, or 328, as described below, for enabling customers to purchase at reduced prices the national and/or store brand products referenced in the articles. It is understood that the coupons provided are not limited to cents-off coupons, but may include other types of discount coupons, such as mail-in rebate coupons. In step 410, a cover is prepared for the publication. The store name, trademark, and/or logo, along with any color scheme and/or trade dress associated with the store are imprinted on the cover. A picture of the products being promoted may also be imprinted on the cover thereof.

In step 412, the foregoing feature articles (including pictures), discount coupons, and cover are published as a brochure in any of a number of conventional manners well-known to those skilled in the art. More specifically, the feature articles are laid out with the pictures appropriately integrated into them. Additionally, the store's name, trademark, and/or logo are laid out as desired on each page of the feature articles, for example, at the top and/or bottom of each page. The feature articles, discount coupons, letter, and cover are mass reproduced and arranged in an order desirable for publication a brochure. The letter is positioned to precede the feature articles, and the discount coupons are positioned by advertisers to tie into the feature articles. The feature articles, discount coupons, and letter are then separately bound together for each brochure, and the cover is secured thereabout.

In step 414, the brochures 324, 326, and 328 are displayed proximate to the product or products for which they are intended to promote. The brochures are thus made available for use and appropriation by customers.

In step 416, selected feature articles written for the foregoing brochures 324, 326, and 328, and discount coupons associated with the selected feature articles, are culled from the brochures at the end of each month for inclusion in a respective magazine 330, 332, or 334. In step 418, a special letter directed to customers from an officer, such as the president, of the store, is prepared for inclusion in the magazine. In step 420 the discount coupons and feature articles selected in step 416 and the letter prepared in step 418 are bound in a conventional manner to form the magazine 330, 332, or 334, which magazines are produced exclusively for the chain grocery store 310. In step 422, the magazines 330, 332, and 334 are provided with covers that carry the same design and color scheme as the weekly brochures 324, 326, and 328 so that, with a quick glance, even from a distance, a customer will realize that the magazines will be promoting store products with discount coupons as was done with the brochures. In step 424, the magazines 330, 332, and 334 are published in a manner similar to that described above with respect to the brochures steps 406 through 412, though on a larger scale. In step 426, the magazines 330, 332, and 334 are displayed in each department 314, 316, and 318 of the store 310 and, like the brochures 324, 326, and 328, are made available for use and appropriation by customers.

The books 354, 356, 358, and 360 are produced in step 428 at the end of each year or quarter, which period is depicted in FIG. 1 as being at the end of the calendar year (i.e., at the end of December). It is understood though that the year may be year ending at any time during the calendar year. For example, if there is a month when sales are greater than at other times of the year, such as the month of December, then it may be preferable to perform step 428 at the end of November of each year.

In accordance with step 428, the feature articles and associated discount coupons selected for the magazines 330, 332, and 334 are organized according to the department 314, 316, and 318 to which they pertain. In step 430, the discount coupons and feature articles organized for each department 314, 316 and 318 are combined to form a book 354, 356, and 358, respectively, for each department, and a book 360 for the store generally. In step 432, a theme is developed for each product line carried by the departments 314, 316, and 318, and is implemented into the corresponding annual book 354, 356, and 358, respectively, by an authority on the subject. A theme is also developed for the store 310 and implemented into the annual book 360. In step 434, a watermark, showing the name, logo, and/or trademark of the store 310, is formed on the front and rear inside cover pages of the books 354, 356, 358, and 360. In step 436, the books 354, 356, and 358 are provided with outside hardcovers that carry the same design and color scheme as the weekly brochures 324, 326, and 328 and magazines 330, 332, and 334 so that, with a quick glance, even from a distance, a customer will realize that the books promote national and/or store products with discount coupons as was done with the brochures and magazines. In step 438, the books 354, 356, and 358 are displayed in the departments 314, 316, and 318, respectively, and the books 360 are displayed throughout the store 310, and are made available for use and appropriation by the customers.

The present invention has several advantages. For example, the feature articles provide customers with a reason to buy, and the discount coupons, which form an integral portion of each brochure, magazine, and book, make it financially advantageous for them to buy, the promoted national and store brand products. The additional value provided by the brochures, magazines, and books also provides a reason for customers to purchase products from the store 310 rather than a competitor store that does not provide any such additional value. The books, in particular, also give the store immediate prestige, enhance the store's image in the market place, give the store an opportunity to strengthen its position in the marketplace, allow the store to generate new customers resulting in increased profits, educate customers and create a new awareness for the store's products, provide the store with a strong marketing tool, provide the store with a strong promotional vehicle, allow the store to keep its name before its customers on a regular, daily basis, provide the store with a competitive advantage, and enable the store to target market its products.

It is understood that several variations may be made in the foregoing without departing from the scope of the invention. For example, while the store 10 is shown as representing a grocery store, it may represent any retail store, drug store, automotive store, mass merchandising chain store, or the like, having a plurality of departments, such as the five departments A, B, C, D, and E shown in FIG. 1, each of which departments carries a separate line of products. The magazines may be published and displayed during the month preceding or following the month in which the brochures from which the magazines derive their feature articles are displayed. Hence the January magazine 330 may comprise feature articles taken from the brochures 324, 326, and 328 that are displayed during December or February instead of during January. The magazines 330, 332, and 334, may include new feature articles and discount coupons that complement the articles found in concurrently displayed brochures. The books 354, 356, 358, and 360 may be published at intervals other than annually, such as quarterly, or semi-annually, and may be provided at the beginning of a period, such as year or quarter, in which corresponding brochures 324, 326, and 328 are provided. In another variation, the method 400 may be implemented without the brochures, without the magazines, or without the books. Moreover, instead of offering the publications at no cost, the store 10 may sell the publications at a price reduced with respect to competing products.

Although illustrative embodiments of the invention have been shown and described, a wide range of modification, change, and substitution is contemplated in the foregoing disclosure and in some instances, some features of the present invention may be employed without a corresponding use of the other features. Accordingly, it is appropriate that the appended claims be construed broadly and in a manner consistent with the scope of the invention.

What is claimed is:

1. A method for promoting sales of a product carried in a store, the method comprising the steps of:
collecting and assembling information about the product;
referencing the collected and assembled information in a publication;
appending coupons for the product to the publication for enabling customers to purchase the product at a discount; and
displaying the publication for appropriation by customers.

2. The method of claim 1 wherein the step of displaying further comprises displaying the publication proximate to the product.

3. The method of claim 1 further comprising the step of printing on the publication the name of the store.

4. The method of claim 1 further comprising the step of imprinting on the publication a color scheme associated with the store.

5. The method of claim 1 wherein the publication is a first publication and the product is a first product, the method further comprising the step of repeating for a second publication and a second product the steps of collecting, assembling, describing, appending, and displaying, the step of displaying further comprising the step of displaying the second publication in place of the first publication.

6. The method of claim 5 wherein the first and second publications are first and second brochures, respectively.

7. The method of claim 6 further comprising the step of compiling into a magazine the first and second publications.

8. The method of claim 7 further comprising the step of displaying proximate to the product, the magazine for appropriation by customers.

9. The method of claim 7 wherein the magazine is sufficiently similar in appearance to the brochures to be associated by customers with the magazine.

10. The method of claim 1 wherein the product is food and the information includes recipes which list the product as an ingredient.

11. A method for promoting sales of a plurality of products carried by a store, the method comprising the steps of:
creating a plurality of departments of the store, each of which carries at least one of the products;
collecting and assembling information about the products;
referencing the collected and assembled information in a plurality of publications;
appending coupons for the products to the publications for enabling customers to purchase the respective products at a discount; and
displaying the publications, proximate to the respective products being promoted in the publications, for appropriation by customers.

12. The method of claim 11 further comprising the step of providing each publication with similar visual markers to enable customers to identify the publications as part of a series.

13. The method of claim 11 wherein one of the publications comprises brochures published weekly.

14. The method of claim 13 wherein another of the publications comprises magazines published less often than the brochures and the method further comprises the step of incorporating some of the brochures into the magazines.

15. The method of claim 14 wherein another of the publications comprises books published less often than the magazines and the method further comprises the step of incorporating some of the magazines into the books.

16. The method of claim 11 further comprising the step of having owners of the products placing advertising within the publications for the products.
